(19) United States
(12) Patent Application Publication
(10) Pub. No.: US 2006/0113252 A1
(43) Pub. Date: Jun. 1, 2006

(54) Irregularly-shaped macroporous copolymer particles and methods of using same

(76) Inventors: Frans Biermans, Zeeland (NL); Norwin von Doehren, Nord Brabant (NL); Jim Crombeen, Zeeland (NL); Rene de Nijs, Zeeland (NL); Teresa Driessen, Zeeland (NL)

Correspondence Address: Varian Inc.;Legal Department, 3120 Hansen Way D-102, Palo Alto, CA, 94304, US

(21) Appl. No.: 10/536,212

(22) PCT Filed: Nov. 25, 2002
(86) PCT No.: PCT/US02/37828

§ 371 Date: May 24, 2005

(51) Int. Cl. B01D 15/08

(52) U.S. Cl. 210/656; 210/198.2; 435/6

(57) ABSTRACT

A matrix comprising irregularly-shaped macroporous copolymer particles is disclosed. The matrix can be employed liquid chromatography applications, such as detecting the presence or absence of a heteroduplex structure in a mixture of hetero- and homoduplex structures. The non-monolithic crushed macroporous copolymer network can be packed in a chromatography column, and such columns facilitate high resolution separations, while maintaining low back pressures, short separation times and long column lifetimes. The irregularly-shaped macroporous copolymer particles can also be employed in analyte isolation operations.

### FIELD OF THE INVENTION

The invention generally relates to chromatography materials and methods of making and using such materials. More particularly, the invention relates to irregular shaped macroporous copolymeric particles that can be employed in a range of chromatographic applications, for example HPLC, DHPLC and RPIPC separations.

Abbreviations

| | |
|---|---|
| DHPLC | denaturing high performance liquid chromatography |
| HPLC | high performance liquid chromatography |
| LC | liquid chromatography |
| RPIPC | reversed phase ion paring chromatography |

### BACKGROUND OF THE INVENTION

Liquid chromatography (LC) is employed to separate a mixture of analytes into its component parts. Traditionally, LC has been employed both qualitatively and quantitatively. For example, LC in general, and high performance liquid chromatography (HPLC) in particular, has been employed to isolate proteins and nucleic acids from biological samples. Researchers have come to heavily rely on LC with the development of high-throughput screening methods to purify analytes such as synthetic and natural oligomers and polymers.

LC is not limited to quantitative and qualitative analysis and isolation of analytes, however. Chromatographic methods have been employed in a range of operations. For example, as disclosed further herein, denaturing HPLC (DHPLC) has been employed in the detection of mutations that can be indicative of genetic conditions. Reversed phase ion-pairing chromatography can be employed to separate nucleic acid sequences of different sizes.

Liquid chromatography generally entails the use of a mobile phase and a stationary phase. The mobile phase is a liquid or a mixture of liquids and typically the stationary phase is a solid. In all liquid chromatographic separations, a sample comprising one or more analytes of interest is diluted in a solvent and contacted with a stationary matrix. The stationary phase has the properties of an adsorbent upon which the components of the mobile phase can be adsorbed. The mobile phase, which can comprise an analyte, is then applied to the stationary matrix. The analytes of the sample can associate to varying degrees with the stationary matrix. As the mobile phase flows along the stationary phase, the components continually adsorb onto, and desorb from, the stationary phase at a rate specific for a particular component. The composition of the mobile phase can be varied to elute the analytes from the stationary matrix at different times. The time at which an analyte elutes from the stationary phase will be a function of the nature of the analyte and the nature of the mobile and stationary phases. Thus, a gradient can be employed in the separation of a mixture of analytes, with each component eluting from the stationary phase at a different mobile phase composition and, thus at a different time point.

One factor that can influence the performance of a liquid chromatographic separation is the stationary phase. Stationary phases can be either monolithic in nature or based on particles. Monolithic stationary phases can be based on organic polymeric material or based on silica. Within stationary phases based on particles there is a difference in stationary phases made from spherical particles and irregularly shaped particles. Spherical particles can be polymer based or silica based. The spherical particles can be porous or non-porous. Modification of the surface of these particles can be performed to obtain a surface with the desired properties. Although irregularly-shaped particles are normally based on silica, the present invention employs irregularly-shaped macroporous copolymeric particles as a stationary phase in liquid chromatography.

A variety of stationary matrices are known. For example, U.S. Pat. No. 6,238,565 to Hatch discloses a monolithic polymer matrix for the separation of bio-organic molecules. This matrix might be useful in the separation of nucleic acids, however this matrix is monolithic in nature.

U.S. Pat. No. 6.056,877 to Gjerde et al. discloses coated nonporous beads that are purportedly useful for separating mixtures of polynucleotides. Similarly, U.S. Pat. No. 5,585,236 to Bonn et al. discloses nonporous beads alkylated with alkyl chains having at least three carbons. Spherical beads, however, can pack tightly in a chromatography column. Spherical beads having small particle diameters can adversely affect the resolution of a given separation and lead to high backpressures. Nonporous particles also have a surface area that is less than that of porous structures of the same particle diameter, which can require higher pressures to resolve a sample. High backpressures can be problematic for many instruments. High backpressures can lead to damage to the tubing, fittings and other hardware, as well as the chromatographic bed of a column, thus limiting the effective lifetimes of these components and potentially the instrument itself.

U.S. Pat. No. 5,880,240 to Tsuno discloses an alkyl-containing porous resin. This patent discloses the formation of particles by suspension polymerization. The formed particles are spherical in shape. However, In order to obtain a material suitable for use as a chromatographic packing the particles need to be classified by size after their synthesis. This classification is performed in order to identify particles that can be employed as a packing. This process requires highly sophisticated equipment and can therefore be cost-prohibitive. Additionally, this resin is not macroporous.

Additionally, many silica-based matrices are known (see, e.g., Unger, Porous Silica, Journal of Chromatography Library Series, Vol. 16, Elsevier, Amsterdam, Holland (1979); Unger, (ed.): Packings and Stationary Phases in Chromatouphic Techniques, Marcel Dekker, New York, N.Y., USA (1990); and Scott, Silica Gel & Bonded Phases—Their Production, Properties, & Use in LC, John Wiley and Sons, New York, N.Y., (1993)) and have been employed as stationary phases in chromatographic separations. Silica-based matrices feature high mechanical stability, however such matrices are susceptible to degradation when they are exposed to some solvents and conditions that can be useful in LC separations.

What is needed, then, is a packing that can be employed as a stationary phase in LC applications. Such a material would comprise a macroporous material, but would not suffer from decreased mechanical stability. Such a material would also be resistant to silica-aggressive solvents and elevated temperatures, thus facilitating DHPLC analyses to be performed. These and other problems are solved by the compositions and methods of present invention.

### SUMMARY OF THE INVENTION

A liquid chromatography column is disclosed. In one embodiment, the column comprises: (a) a matrix adapted for use in a chromatography technique selected from the group consisting of denaturing high performance liquid chromatography, high performance liquid chromatography and reversed phase ion paring chromatography, the matrix comprising irregularly-shaped macroporous copolymer particles; and (b) a durable support structure. A durable support structure can be selected from the group consisting of a stainless steel tube, a PEEK™ tube, an HDPE tube, a glass tube and a steel tube, for example. Metal or plastic materials can be employed as a support, and other suitable materials will be known to those of skill in the art.

In one embodiment, the irregularly-shaped macroporous copolymer particles can be formed by: (a) providing a polymerization mixture comprising a monomer and a crosslinker; and (b) while stirring the polymerization mixture, employing a polymerization technique selected from the group consisting of chain-growth polymerizations and step-growth polymerizations to form irregular-shaped macroporous copolymeric particles. In this embodiment, the monomer can comprise a molecule comprising a polymerizable vinyl group. The chain polymerization can comprise free radical-initiated polymerization, and the step polymerization can comprise condensation polymerization.

In another embodiment, the irregularly-shaped macroporous copolymer particles can be formed by: (a) polymerizing a monomer to form a structurally rigid material by employing a polymerization technique selected from the group consisting of chain-growth polymerizations and step-growth polymerizations; and (b) disrupting the structural integrity of the structurally rigid material to form a powder. In this embodiment, the monomer can comprise a molecule comprising a polymerizable vinyl group. The chain polymerization can comprise free radical- initiated polymerization, and the step-growth polymerization can comprise condensation polymerization.

A liquid chromatography method of isolating an analyte from a sample known or suspected to comprise an analyte is also disclosed. In one embodiment, the method comprises:

(a) contacting a sample known or suspected to comprise an analyte with a matrix comprising irregularly-shaped macroporous copolymer particles; and (b) isolating the analyte from the matrix by employing a technique selected from the group consisting of HPLC, DHPLC and RPIPC. An analyte can comprise, for example, an organic molecule, for example a polymer, an inorganic molecule or a biomolecule, for example a nucleic acid, a nucleic acid oligomer, a peptide or a protein. Nucleic acids and nucleic acid oligomers can comprise mutant nucleic acids and nucleic acid oligomers. A method of separating a mixture comprising double stranded DNA segments of different lengths, the method comprising: (a) contacting a mixture known or suspected to comprise double stranded DNA segments of different lengths with an ion pairing agent to form an ion paired species; (b) contacting the ion paired species with a matrix comprising irregularly-shaped macroporous copolymer particles; and (c) eluting the double stranded DNA segments with an elution solvent. An ion pairing agent can be selected from the group consisting of alkylammonium salts of organic acids and alkylammonium salts of inorganic acids and an elution solvent can be water, an organic solvent, such as methanol or acetonitrile, or an aqueous buffer.

A method of separating a homoduplex nucleic acid structure from a heteroduplex nucleic acid structure is disclosed. In one embodiment, the method comprises: (a) providing a mixture known or suspected to comprise at least one structure selected from the group consisting of a hornoduplex nucleic acid structure and a heteroduplex nucleic acid structure, the mixture further comprising an ion-paring reagent; (b) contacting the mixture with a matrix comprising irregularly-shaped macroporous copolymer particles under conditions known or suspected to partially denature at least one structure; (c) eluting the nucleic acid structures with an elution solvent, whereby a homoduplex nucleic acid structure is separated from a heteroduplex nucleic acid structure. An ion pairing reagent can be, for example, an alkylammonium salts of an organic acid or an alkylammonium salt of an inorganic acid. An elution solvent can be water, an organic solvent, such as methanol or acetonitrile, or an aqueous buffer.

### BRIEF DESCRIPTION OF THE DRAWINGS

FIG. 1 is a schematic diagram depicting the formation of homo-and heteroduplexes.

FIG. 2 is a DNA chromatogram from HaeIII digest of the plasmid pUC18.

FIG. 3 is a DNA chromatogram from a segment of mutant DNA (DYS271).

### DETAILED DESCRIPTION OF THE INVENTION

I. Definitions

Following long-standing patent law convention, the terms “a” and “an” mean “one or more” when used in this disclosure, including the claims.

As used herein, the term “about”, when referring to a value or to an amount of mass, weight, time, volume, concentration or percentage is meant to encompass variations of ±20% or ±10%, more preferably ±5%, even more preferably ±1%, and still more preferably ±0.1% from the specified amount, as such variations are appropriate to perform the disclosed method.

As used herein, the term “adsorb”, and grammatical derivatives thereof, means a surface phenomena wherein an analyte becomes reversibly associated with the surface of a polymeric sorbent by physically interacting with the surface molecules. The association can be, for example, via any non-covalent mechanism (e.g., van der Waal's forces, such as dipole-dipole interactions, dipole-induced dipole or dispersive forces, via hydrophobic interactions or hydrogen donor or acceptor interactions).

As used herein, the term “analyte” means any molecule of interest. An analyte can be disposed in a sample, and can form a component thereof. For example, a nucleic acid sequence or a protein can be an analyte, and the analyte can be disposed in a biological matrix, for example, a blood plasma sample. An analyte can also be disposed in a buffer or synthesis medium. Summarily, an analyte can comprise any molecule of interest and can be disposed in any kind of sample.

As used herein, the term “associated” means a joining of two or more chemical entities. An association can be via a covalent or via non-covalent bond (e.g., hydrophobic interaction, hydrogen bonding, ionic interactions, van der Waals' forces and dipole-dipole interactions).

As used herein the term “bioinorganic molecule” means any molecule that is involved in a process in a living organism that is not an organic molecule. The term also encompasses chelated complexes.

As used herein, the term “biomolecule” means any molecule that is involved in a process (e.g., a metabolic process) in a living organism. Examples of biomolecules include nucleic acids, carbohydrates, proteins and peptides, lipids and combinations and multiples thereof. Molecules such as water molecules are also encompassed by the term.

As used herein, the term “complementary DNA (cDNA)” means a first single-stranded DNA molecule that is adapted to form a duplex with a second single-stranded DNA molecule via Watson-Crick basepairing rules. Those of ordinary skill in the art also use the term “cDNA” to refer to a double-stranded DNA molecule consisting of such a single-stranded DNA molecule and its complementary DNA strand.

As used herein, the term “durable” means able to withstand pressures of between about 10 psi and about 10,000 psi, for example between about 3000 psi and about 4000 psi. This range of pressures is commonly associated with the pressures attained in high pressure chromatography columns, such as HPLC, DHPLC and RPIPC columns. The term also encompasses a resistance to solvents typically employed in such separations, including acetonitrile, methanol and aqueous buffer solutions.

As used herein, the term “heteroduplex” means a complex comprising two different members, for example, two nucleic acid (e.g., DNA) strands, in which the strands have less than 100% sequence complementarity according to standard Watson-Crick base pairing rules.

As used herein, the term “homoduplex” means a complex comprising two complementary members, for example two nucleic acid (e.g., DNA) strands in which the strands have 100% sequence complementarity according to standard Watson-Crick base pairing rules.

As used herein, the term “ion-pairing agent” is a chemical agent adapted to interact with one or more ionized or ionizable groups in a sample. The term “ion-pairing agent” encompasses both the chemical agent itself and a solution comprising the chemical agent. The selection of an ion-pairing agent can depend upon the number and types (e.g., cationic or anionic) of charged sites in a sample to be separated.

As used herein, the term “isolated” means a nucleic acid sequence that is substantially free of other nucleic acids, proteins, lipids, carbohydrates or other materials with which they can be associated, such association being either in cellular material or in a synthesis medium. The term can also be applied to polypeptides, in which case the polypeptide will be substantially free of nucleic acids, carbohydrates, lipids and other undesired polypeptides.

As used herein, the term “macroporous” is used as a descriptor and means having pores equal to or greater than about 500 Å in diameter (PaDirer, Adsorption on Silica Surfaces, Marcel Dekker, New York, N.Y., USA, (2000), p. 582). Porosity can be determined via any known protocol, for example, via a mercury porosity measurement.

As used herein, the term “monolithic,” and grammatical derivations thereof, means a mixture comprising a solid phase and a gas and/or liquid phase. In a monolithic structure all phases are continuous in nature.

As used herein, the terms “nucleic acid” and “nucleic acid sequence” refers to any of deoxyribonucleic acid (DNA), ribonucleic acid (RNA), oligonucleotides, fragments generated in vivo, or by the polymerase chain reaction (PCR), as well as fragments generated by any of ligation, scission, endonuclease action, and exonuclease action. Nucleic acids can comprise monomers that are naturally-occurring nucleotides (such as deoxyribonucleotides and ribonucleotides), or analogs of naturally-occurring nucleotides (e.g., □-enantiomeric forms of naturally-occurring nucleotides), or a combination of both. Modified nucleotides can comprise modifications in sugar moieties and/or in pyrimidine or purine base moieties. Sugar modifications include, for example, replacement of one or more hydroxyl groups with halogens, allkyl groups, amines, and azido groups, or sugars can be functionalized as ethers or esters. Moreover, the entire sugar moiety can be replaced with sterically and electronically similar structures, such as aza-sugars and carbocyclic sugar analogs. Examples of modifications in a base moiety include alkylated purines and pyrimidines, acylated purines or pyrimidines, or other well-known heterocylcic substitutes. Nucleic acid monomers can be linked by phosphodiester bonds or analogs of such linkages. Analogs of phosphodiester linkages include phosphorothioate, phosphorodithioate, phosphoroselenoate, phosphorodiselenoate, phosphoroanilothioate, phosphoranilidate, phosphoramidate, and the like. The term “nucleic acid” also includes so-called “peptide nucleic acids,” which comprise naturally-occurring or modified nucleic acid bases attached to a polyamide backbone. Nucleic acids can be either single stranded or double stranded. Thus, the term “nucleic acid” encompasses molecules synthesized in vivo as well as those synthesized in vitro.

As used herein, the term “oligomer” means a sequence of two or more chemical units that are covalently joined together to form a single sequence. An oligomer can comprise, for example, two or more nucleic acids chemically bound to each other to form an ordered sequence.

As used herein, the term “organic molecule” means any molecule comprising one or more, or a combination of some or all of, carbon, hydrogen, nitrogen, oxygen and phosphorus atoms.

As used herein, the term “partially denatured” means a DNA molecule in which one or more complementary base pairs of the duplex are not hydrogen bonded according to the standard Watson-Crick base pairing rules. Partial denaturation can facilitate distinguishing a heteroduplex from a homoduplex molecule of about the same size. Partial denaturation can also be employed to distinguish a first homoduplex from a second homoduplex of about the same size or a first heteroduplex from a second heteroduplex of about the same size. In accordance with the present invention, such denaturing conditions can be either chemically (e.g., resulting from pH conditions) or temperature-induced, or can be the result of both chemical and temperature factors.

As used herein, the term “porogenic solvent” means any solvent that is present in, but does not take part in, a polymerization process, such as the free radical initiated polymerization of two or more monomers.

As used herein, the term “protein” means any polymer comprising any of the 20 protein amino acids, or amino acid analogs, regardless of its size. Although “protein” is often used in reference to relatively large polypeptides, and “peptide” is often used in reference to small polypeptides, usage of these terms in the art overlaps and varies. The term “polypeptide” as used herein refers to peptides, polypeptides and proteins, unless otherwise noted. As used herein, the terms “protein”, “polypeptide” and “peptide” are used interchangeably herein.

As used herein, the term “reversed phase ion-pairing chromatography” means a chromatographic method for separating samples. The method employs a reversed phase column and an ion-pairing agent. In reversed phase ion-pairing chromatography, some or all of the components of a sample (e.g., analytes) can contain functional groups, which are ionized or are ionizable.

As used herein, the term “DNA segment” means a DNA molecule that has been isolated free of total genomic DNA of a particular species. The term can also mean a DNA molecule that is isolated from proteins that sometimes associate with DNA in vivo, as well as a DNA molecule that is isolated from a reaction mixture, in the event that the DNA segment was synthesized or amplified in a PCR reaction. Included within the term “DNA segment” are DNA segments and smaller fragments of such segments, and also recombinant vectors, including, for example, plasmids, cosmids, phages, viruses, and the like.

As used herein, the term “mutation” and grammatical derivatives thereof, such as the term “mutant”, carry their traditional connotation and mean a change, inherited, naturally occurring or introduced, in a nucleic acid or polypeptide sequence, and is used in its sense as generally known to those of skill in the art. As used herein, the terms “chain-growth polymerization” and “chain polymerization” are used interchangeably and mean a polymerization in which a polymer chain or a polymeric network grows only by reaction of a monomer with a reactive endgroup on the growing chain or polymeric network. Commonly, a chain growth polymerization mechanism comprises an initial reaction between the monomer and an initiator to start the growth of a chain or the polymeric network

As used herein, the terms “step-growth polymerization” and “step polymerization” are used interchangeably and mean a polymerization in which a polymer chain or a polymeric network grows step-wise via a reaction that can occur between any two molecular species. Step-growth polymerizations involve successive reactions between pairs of mutually-reactive functional groups which are initially provided by the monomer(s).

II. General Considerations

Liquid chromatography, for example high performance liquid chromatography (HPLC), generally refers to a technique for partitioning a sample, or more specifically the components of a sample, between a mobile Phase, which can comprise a mixture of one or more organic solvents, water and a buffer (which can comprise an ion pairing agent), and a stationary phase. Liquid chromatography generally employs a solid phase, which is typically packed in a column or cartridge to form a chromatographic bed, and a mobile phase, which is passed over and/or through the chromatographic bed. Many types of solid phases are available, with each different type of solid phase being optimized for the separation of one or more analytes. For example, some solid phases are preferred for separating biological molecules, while others are preferred for separating small organic molecules. Each solid phase has its own unique properties and, while a given solid phase might be useful in one given application (e.g., SPE), it might not be useful in another application (e.g., DHPLC).

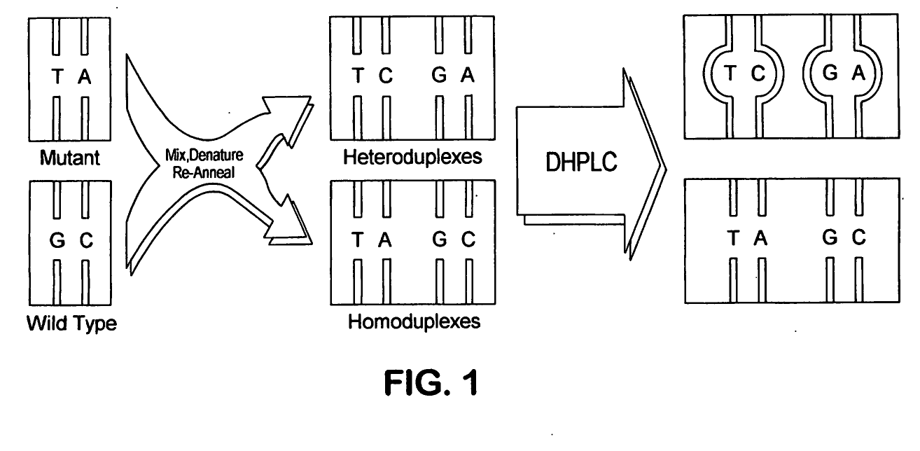

In one application, denaturing high performance liquid chromatography (DHPLC) can be 30 employed to identify a mutation in a nucleic acid sequence based on the separation of heteroduplex molecules containing a single base mismatch from homoduplex molecules. In one embodiment of a DHPLC method, a nucleic acid sample isolated from a sample known or suspected of containing a mutation (which can be amplified by PCR) is mixed with a nucleic acid sequence isolated from a known reference sample (e.g., a sample isolated from a wild-type source). The mixture is heated to melt the existing homoduplexes to single stranded components and is then allowed to slowly cool. During the cooling process, the single stranded DNA molecules re-associate to double stranded DNA molecules. By this way homo- and heteroduplexes form; the members of the heteroduplexes can be different by one or more one base pairs. See FIG. 1.

The mixed population of nucleic acids is then applied to a DHPLC column. The nucleic acids that associate with the column are then subjected to conditions that will partially denature any heteroduplexes associated with the column. Such conditions can include elevated temperatures and/or certain pH conditions.

When the partial denaturing involves elevated temperatures, these temperatures can be achieved by heating the DHPLC column. The operating temperature of the column can be selected (software to assist in the selection of a suitable temperature is commercially available, e.g., from about 50° C. to about 70° C.) so that partial denaturation begins to occur in the area around a mismatch in the heteroduplex. Due to the contributions of several factors, when the loaded column is washed with mobile phase, different retention times for heteroduplexes and homoduplexes are observed and each of which elutes at a different time, effectively separating the heteroduplexes from the homoduplexes, and thus the duplexes comprising a mutation (i.e. heteroduplexes) from those that do not (i.e. homoduplexes).

III. Preparation of Irregularly-Shaped Macroporous Copolymeric Particles

In one embodiment, the Irregularly-shaped macroporous copolymeric particles of the present invention can be formed in several ways. In one embodiment, irregularly-shaped macroporous copolymer particles are formed by first polymerizing two or more monomers to form a polymeric block. Subsequently, the polymeric block is crushed to form irregularly- shaped macroporous copolymeric particles in the form of a powder.

In another embodiment, the irregularly-shaped macroporous copolymer particles are formed by providing a polymerization mixture comprising a monomer and a crosslinker; and while stirring the polymerization mixture, employing a polymerization technique selected from the group consisting of chain-growth polymerizations and step-growth polymerizations to form irregular-shaped macroporous copolymeric particles.

In one method of preparing irregular shaped macroporous copolymeric particles of the present invention, monomers are polymerized by a chain-growth polymerization technique, such as free radical-initiated polymerization to form a polymeric block. In this approach, a monomer can be polymerized in the presence of a crosslinking agent, a polymerization initiator and a porogenic solvent to form a polymeric block.

In one example of a free radical-initiated polymerization process, a homogeneous mixture comprising monomer, a crosslinking agent, a polymerization initiator and a porogenic solvent is formed. The mixture is then purged with a gas that is inert with respect to the polymerization reaction, such as nitrogen or argon. The mixture is allowed to polymerize, which process can be initiated by the polymerization initiator, under conducive conditions, such as about 70° C., for a desired period of time, for example about 16 hours. After washing the material with a suitable solvent to remove undesired components (e.g., acetone), the material can be dried, for example in an oven or by vacuum.

Representative monomers, crosslinking agents, polymerization initiators and porogenic solvents are provided herein. A monomer can generally comprise any molecule comprising a polymerizable vinyl group (e.g., a styrene, a substituted styrene, an acrylate or a substituted acrylate).

Many polymerization initiators are known and can be employed in radical-induced polymerization to form a polymeric block. Generally, compounds that generate free radicals by treatment of the compound with heat or radiation (e.g., UV-light) can be employed, although free radical species can themselves be employed. A non-limiting list of representative of polymerization initiators includes azocompounds, alkylperoxides, acylperoxides, hydroperoxides, ketone peroxides, peresters, and peroxycarbonates.

A range of crosslinking agents is also available for performing a free radical initiated polymerization. Generally a crosslinking agent can be, a molecule comprising two or more polymerizable vinyl groups. For example, aryl divinyl monomers, such as divinylbenzene, and bis(acrylates) can be employed as a crosslinking agent.

Other polymerization methods can also be employed to form a polymeric block, such as other chain-growth polymerizations (e.g., anionic polymerization, cationic polymerization, and thermal polymerization of vinyl containing monomers).

Step-growth polymerization techniques can also be employed, such as condensation polymerization of appropriate monomers can be employed to form a polymeric block. These methods involve different mechanisms but each can be employed to form a polymeric block. Methods of carrying out each of these types of polymerization reactions are have been developed and will be known to those of ordinary skill in the art.

After forming a polymeric block, the structural integrity of the polymeric block can then be disrupted. Disruption can be carried out by any means that physically reduces the polymeric block to a dispersed powdered form. In one example, a polymeric block can be crushed by forcefully applying a spatula to the material. Other crushing techniques, such as a ball mill, can also be employed to disrupt the structural integrity of a polymeric block. Upon disruption of a polymeric block, irregularly-shaped macroporous copolymeric particles of the present invention are formed. It will often, but not always, be desirable to reduce the polymeric block to a powder comprising particles of approximately uniform size and/or a powder comprising particles of a narrow size distribution. Thus, the product of the disruption of a polymeric block is a collection of irregularly-shaped macroporous copolymeric particles.

In yet another method of forming the irregularly-shaped macroporous copolymeric particles of the present invention, polymerization of a monomer with stirring can be employed. The stirring action during the polymerization step can facilitate the formation of particles. This method can be employed as an alternative to forming a block and crushing it. In one embodiment of the method, a polymerization mixture comprising a monomer and a crosslinker is provided. Representative monomers and crosslinkers are described herein.

Continuing with the embodiment, while stirring the polymerization mixture, a polymerization technique selected from the group consisting of chain-growth polymerizations and step-growth polymerizations is employed to form irregular-shaped macroporous copolymeric particles. As described herein, one example of a chain-growth polymerization technique is free radical-initiated polymerization. An example of a step-growth polymerization is condensation polymerization.

V. Properties of a PolyMeric Sorbent

The following sections provide additional detail of the properties of irregularly-shaped macroporous copolymeric particles of the present invention, as well as methods of characterizing irregularly-shaped macroporous copolymeric particles that was prepared as described herein.

V.A. Longevity of a Polymeric Material

Typically, the performance of a given LC column (e.g., an HPLC, DHPLC or RPIPC column) will diminish over time. This effect can be due to a variety of factors. For example, when a guard column is not routinely employed, repeated applications of impure or contaminated samples to the column can lead to irreversible association of undesirable components with the column. Additionally, application of impure or contaminated samples can lead to clogging of the column and increased column back pressures, which can lead to undesirable changes in the packing of the solid phase within a column. If an unsuitable solvent is employed as a mobile phase, this practice can also affect column performance in subsequent separations and the integrity of the solid phase itself. In yet another example, when the column is repeatedly stressed, for example by heating the column, a practice that forms a step in some DHPLC separations, the performance of the column can decrease with each successive heating step. Most commonly, and even with proper care, the performance of a column decreases over time due to normal wear and tear.

Sometimes, a damaged or contaminated column can be regenerated by treating the column with a series of solvents or by back flushing the column to remove contaminating materials. Often, however, an old or damaged column must be discarded and replaced with a fresh column. This can be a significant financial consideration.

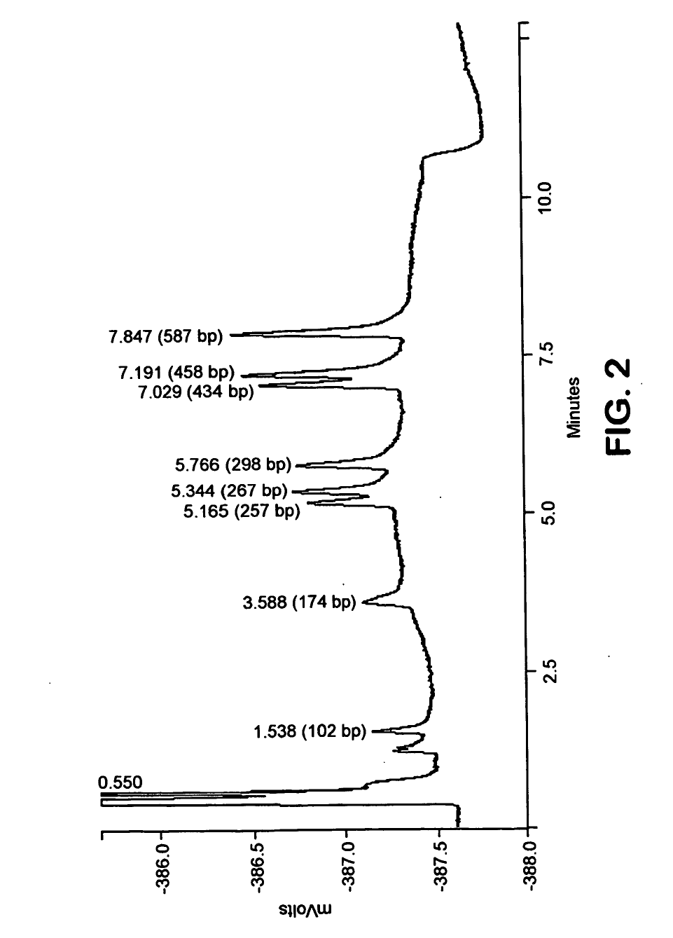

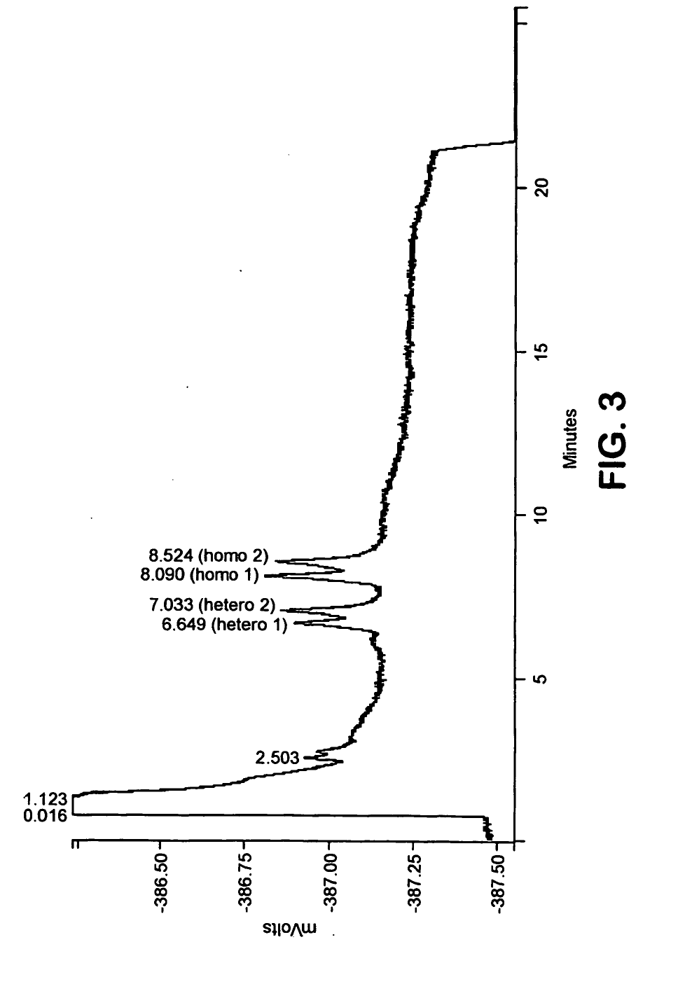

In one aspect, the irregularly-shaped macroporous copolymeric particles of the present invention exhibit a longer effective lifetime than other DHPLC, HPLC and RPIPC matrices. For example, as shown in FIGS. 2 and 3, at least about 2700 separations or more can be performed at 60° C. on a column packed with the irregularly-shaped macroporous copolymeric particles of the present invention. As the data of FIGS. 2 and 3 indicate, the resolution of the separations does not diminish over time.

Thus, a column packed with the irregularly-shaped macroporous copolymeric particles of the present invention, on the other hand, offers a longer effective life than many other available columns. A prolonged effective column life can translate into an economic benefit in that column replacement is more infrequent. This advantage is due, in part, to the durability of the irregularly-shaped macroporous copolymeric particles of the present invention.

V.B. Porosity of the Irregularly-Shaped Macroporous Copolymeric Particles

In another aspect of the present invention, the irregularly-shaped macroporous copolymeric particles of the present invention features high porosity. This property, in part, allows the irregularly-shaped macroporous copolymeric particles to be easily packed into chromatography columns, such as HPLC, DHPLC and RPIPC columns. Due to the flexible structure of the packing bed, the performance of a column packed with the irregularly-shaped macroporous copolymeric particles of the present invention is less affected by swelling and shrinking, which can sometimes accompany column preparation and/or packing. For example, compared with a column packed with a monolithic miaterial, the packing bed of a column packed with the irregularly-shaped macroporous copolymeric particles of the present invention is less affected by swelling and shrinking during column preparation and/or packing.

Further, unlike some chromatograph columns, in a column packed with the irregularly-shaped macroporous copolymeric particles of the present invention, the matrix is not fixed to the wall of the column. In monolithic columns, the monolithic material is bonded to the wall in order to prevent “flow around” by the mobile phase. Since the irregularly-shaped macroporous copolymeric particles are typically packed in a column there is no need for bonding the stationary phase to the walls of a support.

Additionally, the high porosity of the irregularly-shaped macroporous copolymeric particles of the present invention, coupled with the favorable column packing properties of the material, can lead to lower back pressures in a column packed with irregularly-shaped macroporous copolymeric particles of the present invention. High backpressures can damage the chromatographic bed (i.e., the stationary phase) and shorten the effective lifetime of the column. Therefore, high backpressures are preferably avoided in chromatographic separations whenever possible.

Thus, the porosity of a column packed with the irregularly-shaped macroporous copolymeric particles of the present invention features low backpressures, due to the relative ease with which mobile phase is able to pass through the macropores of the chromatographic bed. Ultimately, this facilitates a longer effective lifetime of the column.

One additional advantage of the low back pressures associated with a column packed with the irregularly-shaped macroporous copolymeric particles of the present invention is that a low backpressure allows a higher linear velocity of the mobile phase through the chromatographic bed. Additionally, materials that generate a low backpressure at a defined flow can also be employed at higher flows because the backpressure these materials generate at higher flows will not damage the system (tuning, fitting, material, etc.) or adversely affect the column. This allows a greater number of separations to be performed over a shorter period of time using acceptable backpressures. LC columns operating a high back pressures do not permit high linear velocities because such conditions elevate the risk of damaging the stationary phase as a consequence of the high pressure gradient. When columns can be operated under low back pressures, higher flows can be employed without damage to the system or column, as described herein. Higher flow rates can enhance the potential for shorter separation times.

Columns employing available stationary phase materials can generate very high backpressures, which can lead to a situation in which the fittings and/or tubing of the LC system in which the column is employed begin to leak or are no longer fixed. Generally, stationary phases (i.e., chromatographic beds) are not tolerant of high shear forces and/or high backpressures. Therefore, such columns are less suited to automated high throughput separation operations. A column packed with the irregularly-shaped macroporous copolymeric particles of the present invention, on the other hand, features low back pressure during separations, which facilitates a greater number of separations in a shorter period of time. This advantage makes columns packed with the irregularly-shaped macroporous copolymeric particles of the present invention useful in high throughput operations.

V.C. Resistance of the Irregularly-Shaped Macroporous Copolymeric Particles to Solvents and pH Conditions

Often, conditions that are particularly desirable for a given separation are not compatible with the solid phase of a packed LC column. For example, the resolution of some separations can be increased when acidic or basic pH conditions are employed. Other separations can benefit from the use of certain solvents as a mobile phase.

Many solid phases, however, have a limited range of conditions under which they can be employed. For example, silica-based stationary phases cannot withstand extreme pH conditions. Under extremely high pH conditions, for example, the silica dissolves, while under extremely low pH conditions, the surface bonded groups hydrolyze off of the silica.

The irregularly-shaped macroporous copolymeric particles of the present invention, on the other hand, are resistant to a wide range of solvent and pH conditions. Due, in part, to the fact that the irregularly-shaped macroporous copolymeric particles of the present invention are polymer-based, the high and low pH conditions that can damage a silica-based material do not affect the irregularly-shaped macroporous copolymeric particles of the present invention. For example, unlike silica-based materials the irregularly-shaped macroporous copolymeric particles of the present invention are chemically inert against silica-aggressive buffers, making it suitable for use in DHPLC applications.

Additionally, the irregularly-shaped macroporous copolymeric particles can be employed over a range of pH values not seen in some known solid phases. For example, the irregularly-shaped macroporous copolymeric particles of the present invention can tolerate a wide pH range, namely from about 1 to about 14.

VI. Applications of the Irregularly-Shaped Macroporous Copolymeric Particles

The irregularly-shaped macroporous copolymeric particles of the present invention can generally be employed in any application involving a liquid chromatography-based separation, particularly those involving HPLC, DHPLC and RPIPC separations. The mixture to be separated can comprise, for example, inorganic molecules, organic molecules (e.g., deprotonated acids and protonated bases), metal organic samples (e.g., cis-platin/trans-platin), bioinorganic molecules (e.g., hemoglobin, etc.), biomolecules (e.g., proteins, peptides, nucleic acids, oligomers, etc.), ions (e.g., Fe²⁺, Fe³⁺, Cu²⁺, etc.) and combinations thereof. When the mixture comprises biomolecules, the biomolecules can be, for example, a nucleic acid (DNA and/or RNA), a nucleic acid oligomer, a peptide or a protein.

A column packed with irregular shaped macroporous copolymeric particles of the present invention is useful for separating the components of a mixture, but these separations can form a component of a broader application. For example, such separations can form an aspect of high-throughput screening process or a process designed to identify a nucleic acid mutation, such as a mutation associated with a genetic condition. These and other applications of the polymeric materials of the present invention are described more fully below.

VI.A. Method of Isolating an Analyte from a Sample Known Or Suspected To Comprise an Analyte

In one aspect of the present invention, a method of isolating an analyte from a sample known or suspected to comprise an analyte is disclosed. A sample can derived from any source, although the non-monolithic crushed macroporous copolymer networks and associated methods of the present invention are particularly suited for isolating an analyte from a biological sample. For example, a sample can comprise biological matrix (e.g., blood; plasma, etc.) comprising an analyte (e.g., a nucleic acid, a nucleic acid oligomer, a protein, a mutant nucleic acid or protein, a polymeric species or a small molecule). In other examples, an analyte can comprise an inorganic molecule or, broadly, a biological or non-biological organic molecule.

An analyte can comprise a synthesized or isolated agent known or suspected to have therapeutic activity. Such an agent can optionally be associated with a pharmaceutically- acceptable excipient. In yet another example, a sample can comprise a synthesis medium and an analyte can be a compound synthesized in the medium. In this example, as well as the other applications disclosed herein, the isolation of an analyte can form a component of an automated high-throughput screening process. A representative, but non-limiting, list of analytes includes nucleic acids, proteins and protein nucleic acids. A nucleic acid can comprise oligomers of any length. A protein can comprise an amino acid sequence of any length.

Thus, in one example, an analyte comprises a polymeric molecule, such as a nucleic acid, which comprises two or more nucleic acid monomers, or a protein, which comprises two or more amino acid monomers. Although such analytes can comprise any number of monomeric units, a polymeric analyte will commonly comprise 10, 20, 30, 40 or more monomeric units. Monomers can be similar or different in composition.

Continuing with the method, a sample known or suspected to comprise an analyte is contacted with a matrix comprising irregularly-shaped macroporous copolymer particles. The irregularly-shaped macroporous copolymer particles can be formed as described herein.

The contacting can be performed in any convenient fashion, for example by passing a liquid sample comprising an analyte over the copolymer network. In one embodiment, the material can be disposed in a column as part of an automated chromatography system. In this embodiment, the contacting can be achieved by injecting the sample into an injection port on the chromatography system, which will transmit the sample to the column containing the material. The contacting facilitates the reversible formation of an association comprising an analyte and the irregularly-shaped macroporous copolymer particles of the present invention.

Following the contacting, an analyte is isolated from the matrix by employing a technique selected from the group consisting of HPLC, DHPLC and RPIPC. In operation, isolation of a sample can be achieved by passing a solvent over an analyte associated with the irregularly-shaped macroporous copolymer particles. As the solvent contacts the analyte associated with the irregularly-shaped macroporous copolymer particles, the non-covalent bonds that associate the copolymer network with the analyte are disrupted and the analyte is eluted from the copolymer network. The choice of solvents and conditions will be dependent, in part, on the nature of the isolation technique and the nature of the analyte. Standard LC, HPLC, DHPLC and RPIPC equipment and methodology can be employed and will be apparent to one of ordinary skill in the art upon consideration of the present disclosure.

The method can form a component of an automated high-throughput screening apparatus or method. For example, when HPLC methods are employed in the isolation, the HPLC system can comprise an autosampler, which can facilitate the rapid an unattended analysis of a plurality of samples.

VI.B. Method of Separating a Homoduplex Nucleic Acid Structure from a Heteroduplex Nucleic Acid Structure

In one application, denaturing high performance liquid chromatography is used to identify a mutation in a nucleic acid sequence based on the separation of heteroduplex molecules containing a single base mismatch from homoduplex molecules. In one example, a nucleic acid sample isolated from a sample known or suspected of containing a mutation (which can be amplified by PCR) is mixed with a nucleic acid sequence isolated from a known reference sample (e.g. a sample isolated from a wild-type source). The mixture is heated to melt the existing homoduplexes to single stranded components and is then allowed to slowly cool. During the cooling process, both homo- and heteroduplexes form.

The mixture of formed homo- and hetero duplexes can then be loaded onto a DHPLC column. The DHPLC column can then be heated to partially denature the strands of the homo- and heteroduplexes, for example to a temperature of between about 50° C. and about 70° C. This heating step can be done on an HPLC column by heating up the solvent and the column in an HPLC column oven. The operating temperature of the column can be selected (software to assist in the selection of a suitable temperature is commercially available, e.g., the Star® WorkStation software available from Varian, Inc. of Palo Alto, Calif., USA) so that partial denaturation begins to occur in the area around a mismatch in the heteroduplex. This effect leads to different retention times for heteroduplexes and homoduplexes and each of which elutes at a different time, effectively separating the heteroduplexes from the homoduplexes, and thus the duplexes comprising a mutation (i.e., heteroduplexes) from those that do not (i.e., homoduplexes).

In one aspect of the present invention, a method of separating a homoduplex nucleic acid structure from a heteroduplex nucleic acid structure is disclosed. In one embodiment, the method comprises providing a mixture known or suspected to comprise at least one structure selected from the group consisting of a homoduplex nucleic acid structure and a heteroduplex nucleic acid structure, the mixture further comprising an ion-pairing reagent. Such a mixture can be prepared generally as follows. A nucleic acid sample known or suspected to comprise a mutation can be isolated from a source. The nucleic acid can be amplified by PCR. A second nucleic acid sample, for example a wild type sequence, can also be isolated from a source. The nucleic acid sample known or suspected to comprise a mutation can be incubated with the second wild type sequence. The mixture can be heated to melt any double stranded sequences and cooled to allow double stranded structures to form. If a mutation is present in one strand of a duplex, a mixed population of heteroduplexes and homoduplexes is formed. See FIG. 1.

Continuing with the present embodiment of the method, the mixture is contacted with a matrix comprising irregularly-shaped macroporous copolymer particles under conditions known or suspected to partially denature the hetero- and homo duplex nucleic acid structures. The matrix can be formed as described further herein. The matrix can be disposed in a column, again as further described herein.

Both heteroduplex and homoduplex structures associate with the material via non-covalent interactions. Partially denaturing conditions can comprise, for example, an elevated temperature. In this example, the material, and any duplex structures associated with it, can be heated to a temperature that is known or suspected to partially denature the hetero- and homoduplex nucleic acid structures. When the material is disposed in a support structure, such as a column, the material can be conveniently heated by heating the column itself. Such heating can be achieved by placing the column in a column oven, and the solvent can be warmed in the same oven, via heat exchangers. Many materials cannot be heated to potentially denaturing temperatures without being damaged. In fact, to the best of the inventors' knowledge, the materials disclosed herein are the only irregularly-shaped macroporous copolymeric particles suited for such heating. The material is also resistant to solvents that can be useful for denaturing homo- and heteroduplexes.

When a duplex structure associated with the material is exposed to partially denaturing conditions, heteroduplex structures can begin to melt. Under the same conditions, however, homoduplex structures will not begin to melt. In one example, partially denaturing conditions can comprise a temperature of about 1 degree less than the Tₘ of a duplex structure. Available software can be employed to assist in making an estimate of the Tₘ of a given structure.

Temperatures for carrying out the separation method of the invention can be, for example, between about 50 and 70° C., or, for example, between about 55 and 65° C. Alternatively, in carrying out a separation of GC-rich heteroduplex and homoduplex nucleic acid structures, a higher temperature (e.g., about 64° C.) can be employed, while a lower temperature (e.g., about 56° C.) can be employed when separating nucleic acids having a lower guanine-cytosine (GC) content.

Alternately, conditions selected to partially denature a heteroduplex nucleic acid structure can comprise certain pH conditions, and solvent composition, for example a solvent comprising a high acetonitrile content. Such pH and solvent conditions can be effective to at least partially denature a heteroduplex molecule. In such cases, a lower column temperature can be employed the separation of the heteroduplex and homoduplex nucleic acid structures. Summarily, the combination of the temperature, the ion pairing reagent and the solvent composition can combine to generate a denaturing or partially denaturing environment.

After contacting the mixture with irregular shaped macroporous copolymeric particles under conditions known or suspected to partially denature a heteroduplex nucleic acid structure, nucleic acid structures are eluted with an elution solvent. Preferred solvents for eluting duplexes include acetonitrile and methanol. Under certain conditions, heteroduplexes will elute from the material at a different point in time than do the two separated homoduplexes. This will be evident from an elution chromatogram, which can depict two distinct peaks, each of which can be centered at a different time point; two peaks with different shapes; or a combination of both. Duplexes that elute can be detected by monitoring eluent absorbance at 260 nm, which is characteristic of nucleic acids.

By selecting a suitable temperature and solvent combination, the presence of 4 different types of duplexes, i.e., two types of heteroduplexes and two types of homoduplexes, can be detected when a single base pair point mutation is present in the heteroduplex structure (e.g., a mutant sequence). As noted, heteroduplexes are indicative of the presence of one or more mutations (with respect to the wild type sequence) in a sample.

The above described application is facilitated, in part, by the irregularly-shaped macroporous copolymeric particles of the present invention. Often, the option to employ DHPLC and related applications to detect the presence or absence of heteroduplexes is limited by the durability of the material employed in the separation. More particularly, most separation matrices, such as porous and non-porous derivatized silica beads, various resins and porous and porous monolithic materials, cannot be employed in the detection of heteroduplexes.

VI.C. Liquid Chromatography Column

In yet another aspect of the present invention, a liquid chromatography column is disclosed. Often it will be desirable to situate the irregularly-shaped macroporous copolymer particles of the present invention in a durable support structure, such as a column, in order to employ the material as a stationary phase in a LC column. Such columns can comprise stainless steel, PEEK™, HDPE, glass or titanium steel, for example (metals, plastics and other suitable materials will be known to those of skill in the art), and are fashioned to withstand the pressures and solvents associated with HPLC, DHPLC and RPIPC methods.

Thus, in one aspect of the present invention, an LC column is disclosed. In one embodiment of an LC column of the present invention, a liquid chromatography column comprises a matrix adapted for use in a chromatography technique selected from the group consisting of denaturing high performance liquid chromatography, high performance liquid chromatography and reversed phase ion paring chromatography, the matrix comprising irregularly-shaped macroporous copolymer particles. The particles can be formed as described herein, for example by employing a free radical-initiated polymerization mechanism or a condensation polymerization mechanism followed by crushing the resulting block to a dispersed powder form.

The liquid chromatography column also comprises a durable support structure. The support structure can encapsulate the non-monolithic crushed macroporous copolymer network. Methods for packing the copolymer network in the support structure are known to those of ordinary skill in the art (see, e.g., Unger, (ed.): Packings and Stationary Phases in Chromatographic Techniques, Marcel Dekker, New York, N.Y., USA (1990)) and can be employed in the formation of the liquid chromatography column of the present invention.

Suitable support structures can comprise columns formed from durable materials, such as stainless steel, HDPE, PEEK™, glass, titanium steel and other materials known to be suitable for forming LC columns, such as various metals and plastics. Such support structures will be durable structures and will be adapted to withstand the pressures and solvents normally associated with HPLC, DHPLC and RPIPC separations. Thus, as used herein, the term “durable” means able to withstand pressures of in the range of between about 1 to about 10,000 psi, for example between about 3000 and 4000 psi, and a range of solvents, including acetonitrile, methanol and aqueous buffer solutions.

VI.D. Method of Separating a Mixture Comprising Double Stranded DNA Segments of Different Lengths

In yet another embodiment of the present invention, a method of separating a mixture comprising double stranded DNA segments of different lengths is disclosed. In one embodiment, the method comprises contacting a mixture known or suspected to comprise double stranded DNA segments of different lengths with an ion paring agent to form an ion paired species. The mixture can be isolated from a biological sample or it can comprise the amplification products of a PCR reaction. In another embodiment, the mixture can comprise the product of a nucleic acid synthesis operation. An ion pairing agent can be, for example, an alkylammonium salt of an organic acid or an alklylammonium salt of an inorganic acid. Any compound known or suspect to act as an ion paring agent can be employed, however.

Next, the ion paired species can be contacted with a matrix comprising irregularly-shaped macroporous copolymer particles. The particles can be formed as described herein, for example crushing a block formed by a condensation polymerization or free radical-initiated polymerization mechanism. The matrix can be disposed in a support structure, such as a stainless steel, HDPE, PEEK™ glass or a titanium steel column, for example.

The double stranded DNA segments can then be eluted with an elution solvent. The solvent can comprise, for example, methanol or acetonitrile, either in its pure form or in a diluted form. The composition of an elution solvent can also comprise a mixture of solvents, for example as formed in an elution gradient comprising 2 different solvents (e.g., aceonitrile and water).

The polymeric materials of the present invention offer several advantages over known chromatography materials. One advantage of a polymeric material of the present invention is that a column packed with the material can be operated at a high flow rate with low back pressure. Higher flow rates and lower back pressures can facilitate shorter separation times and more resolved separations. Low back pressure chromatographic separations can also be favorably employed in high-throughput screening operations.

Another advantage of a polymeric material of the present invention is that the material can be employed in a greater number of separations (e.g. nucleic acid separations) than other materials. This longevity is particularly significant with respect to DHPLC separations, the separation conditions of which can quickly render a separation column and its matrix unusable. The polymeric material of the present invention, on the other hand, can be employed in about 2700 or more DIIPLC separations at 60° C. This can translate into an economic advantage, since columns comprising a polymeric material of the present invention will need to be replaced more infrequently than other types of columns.

Yet another advantage of a polymeric material of the present invention is its resistance to a range of solvents, pH conditions and temperatures. These features make the materials of the present invention suited to a variety of applications, including DHPLC-based separations. Traditional silica-based materials are susceptible to certain solvents, limiting the range of applications for these materials. Some porous materials are resistant to several solvents, but these materials suffer from other drawbacks, such as decreased mechanical stability. Additionally, many materials are not suited for high temperature separations, such as those associated with DHPLC. In fact, to the inventors' knowledge, the polymeric materials of the present invention are the only macroporous polymeric based materials exhibiting long-term stability that are known to be suitable for DHPLC applications.

The polymeric materials of the present invention are resistant to swelling and shrinking effects during column preparation and/or packing. This is due, in part, to the fact that when the material is disposed in a column, the material is not fixed to the wall of the column. Shrinking and/or swelling effects can adversely affect the integrity of a chromatographic bed, due to the irreversible formation and shifting of interstitial channels and spaces.

Importantly the materials of the present invention facilitate high resolution separations of protein samples and DNA samples. Additionally, such resolution can be achieved in short periods of time. With the advent of automated compound (e.g., small molecule, peptide and nucleic acid) synthesis, the need to isolate analytes in a rapid and reliable fashion has developed concurrently. The polymeric materials of the present invention meet this need by providing a material that is adapted for protein or nucleic acid separations and that can be employed in high-resolution qualitative or quantitative sample separations, as well as in diagnostic applications (e.g. mutation detection).

Another advantage of the materials of the present invention is that the materials offer desirable packing properties for column preparation. Poorly packed columns can generate large gaps and ruptures, which can lead to a situation in which the mobile phase bypasses portions of the stationary phase, resulting in poor performance. The irregularly formed materials of the present invention, however, are adapted to pack together such that gaps and ruptures do not form, making the separation surface relatively uniform at all points.

Unlike these known materials, the materials of the present invention are easily packed into a column and are not so tightly packed as to inhibit the passage of a mobile phase through the column. Nor do the materials of the present invention pack too loosely, leaving ruptures and gaps in the column matrix. Partly as a result of its structural irregularity and its macroporous nature, the materials of the present invention can pack in a column such that elution times can be shortened without sacrificing performance.

Yet another advantage of the methods and materials of the present invention is that the preparation of the matrix material is simpler than that disclosed for other materials. That is, there are fewer synthetic steps in the preparation of the materials of the present invention, as opposed to synthetic processes known for other materials (e.g., porous or non-porous polymer beads and/or derivatized porous or non-porous silica beads). This simplified preparation procedure, which is disclosed herein, not only makes preparing a material of the present invention easier, it also offers the potential for higher degree of reproducible results. Generally, as the number of steps of a chemical synthesis decrease, the number of variables in the synthesis also decreases, facilitating the production of a more consistently reproducible product.

It will be understood that various details of the invention may be changed without departing from the scope of the invention. Furthermore, the foregoing description is for the purpose of illustration only, and not for the purpose of limitation.

What is claimed is:

1. A liquid chromatography column comprising:
(a) a matrix adapted for use in a chromatography technique selected from the group consisting of denaturing high performance liquid chromatography, high performance liquid chromatography and reversed phase ion paring chromatography, the matrix comprising irregularly-shaped macroporous copolymer particles; and
(b) a durable support structure.

2. The liquid chromatography column of claim 1, wherein the durable support structure is selected from the group consisting of a stainless steel tube, a PEEK™ tube and an HDPE tube, a glass tube and a titanium steel tube.

3. The liquid chromatography column of claim 1, wherein the irregularly-shaped macroporous copolymer particles are formed by:
(a) stirring a polymerization mixture comprising a monomer and a crosslinker; and
(b) while stirring, employing a polymerization technique selected from the group consisting of chain-growth polymerizations and step-growth polymerizations to form irregular-shaped macroporous copolymeric particles.

4. The liquid chromatography column of claim 3, wherein the monomer comprises a molecule comprising a polymerizable vinyl group.

5. The liquid chromatography column of claim 3, wherein the chain polymerization comprises free radical-initiated polymerization

6. The liquid chromatography column of claim 3, wherein the step polymerization comprises condensation polymerization.

7. The liquid chromatography column of claim 1, wherein the irregularly-shaped macroporous copolymer particles are formed by:
(a) polymerizing a monomer to form a structurally rigid material by employing a polymerization technique selected from the group consisting of chain-growth polymerizations and step-growth polymerizations; and
(b) disrupting the structural integrity of the structurally rigid material to form a powder.

8. The liquid chromatography column of claim 7, wherein the monomer comprises a molecule comprising a polymerizable vinyl group.

9. The liquid chromatography column of claim 7, wherein the chain polymerization comprises free radical-initiated polymerization.

10. The liquid chromatography column of claim 7, wherein the step polymerization comprises condensation polymerization.

11. A liquid chromatography method of isolating an analyte from a sample known or suspected to comprise an analyte, the method comprising:
(a) contacting a sample known or suspected to comprise an analyte with a matrix comprising. irregularly-shaped macroporous copolymer particles; and
(b) isolating the analyte from the matrix by employing a technique selected from the group consisting of HPLC, DHPLC and RPIPC.

12. The method of claim 11, wherein the analyte is selected from the group consisting of an organic molecule, an inorganic molecule, a bioinorganic molecule, an ion and a biomolecule.

13. The method of claim 12, wherein the organic molecule is a polymer.

14. The method of claim 12, wherein the biomolecule is selected from the group consisting of a nucleic acid, a nucleic acid oligomer, a peptide and a protein.

15. The method of claim 14, wherein the nucleic acid oligomers are selected from the group consisting of DNA, mutant DNA, RNA, and mutant RNA.

16. The method of claim 11, wherein the method is automated.

17. A method of separating a mixture comprising double stranded DNA segments of different lengths, the method comprising:
(a) contacting a mixture known or suspected to comprise double stranded DNA segments of different lengths with an ion pairing agent to form an ion paired species;
(b) contacting the ion paired species with a matrix comprising irregularly-shaped macroporous copolymer particles; and
(c) eluting the double stranded DNA segments with an elution solvent.

18. The method of claim 17, wherein the ion pairing agent is selected from the group consisting of alkylammonium salts of organic acids and alkylammonium salts of inorganic acids.

19. The method of claim 17, wherein the elution solvent is selected from the group consisting of water, an organic solvent and an aqueous buffer.

20. The method of claim 19, wherein the organic solvent is selected from the group consisting of organic solvents mixable with water, acetonitrile, methanol, and THF.

21. The method of claim 17, wherein the method is automated.

22. A method of separating a homoduplex nucleic acid structure from a heteroduplex nucleic acid structure, the method comprising:
(a) providing a mixture known or suspected to comprise at least one structure selected from the group consisting of a homoduplex nucleic acid structure and a heteroduplex nucleic acid structure, the mixture further comprising an ion-paring reagent;
(b) contacting the mixture with a matrix comprising irregularly-shaped macroporous copolymer particles under conditions known or suspected to partially denature the at least one structure;
(c) eluting the nucleic acid structures with an elution solvent, whereby a homoduplex nucleic acid structure is separated from a heteroduplex nucleic acid structure.

23. The method of claim 22, wherein the ion pairing reagent is selected from the group consisting of an alkylammonium salt of an organic acid and an alkylammonium salt of an inorganic acid.

24. The method of claim 22, wherein the elution solvent is selected from the group consisting of water, an organic solvent and an aqueous buffer.

25. The method of claim 24, wherein the organic solvent is selected from the group consisting of acetonitrile and methanol.

26. The method of claim 22, wherein the method is automated.

27. The method of claim 22, wherein the method is repeated a desired number of times.
